(19) United States
(12) Patent Application Publication
(10) Pub. No.: US 2002/0128113 A1
(43) Pub. Date: Sep. 12, 2002

(54) Control system for a continuously variable traction drive

(76) Inventor: Thomas Theodore Tibbles, Livonia, MI (US)

Correspondence Address: Donald J. Harrington, Brooks & Kushman, Twenty-Second Floor, 1000 Town Center, Southfield, MI, 48075-1351, US

(21) Appl. No.: 09/754,164

(22) Filed: Jan. 4, 2001

(51) Int. Cl. F16H 61/30; F16H 15/38

(52) U.S. Cl. 476/10

(57) ABSTRACT

A control valve system for controlling the ratio of a traction drive variator comprising a pair of toroidal torque input discs and a pair of toroidal torque output discs with torque transmitting rollers situated between the disc. A pair of pressure actuators which establish the position of the rollers relative to the torque input discs and the torque output discs. Pressure differential across the pressure actuators is controlled by a valve assembly comprising a ratio valve connected to a valve actuating lever, one end of the lever being activated by an adjustable element of the variator and the other end being activated by a ratio stepper motor. A cam and lever arrangement is used to translate movement of the rollers in a motion feedback fashion to the ratio valve so that a null position of the ratio valve will be established as pressure differential across the actuator reaches a null state.

### BACKGROUND OF THE INVENTION

1. Field of the Invention

The invention relates to a continuously variable traction drive for transferring engine torque to a torque output shaft in a vehicle powertrain.

2. Background Art

Transmission mechanisms with continuously variable torque ratio characteristics have been used in automotive vehicle powertrains to improve fuel economy while providing a smooth ratio change without the usual shift discontinuities associated with conventional stepped transmissions. A continuously variable transmission will achieve a large ratio range with a potential for a lower engine speed for a given power output. This generally improves fuel consumption by reducing throttle losses as the engine operates relatively close to its minimum brake-specific fuel consumption point.

Infinitely variable transmissions employing a belt drive between two adjustable pulley assemblies are well known in the art. These belt drives have a limited torque capacity, however, especially when they are located at the torque output side of a hydrokinetic torque converter in an automotive vehicle driveline. This makes them unsuitable for use with large engines in a heavy-duty vehicle powertrain.

Higher torques can be achieved using traction drive rollers, which transfer power using torque transfer elements such as toroidal discs. Torque transfer through the rollers between the discs occurs through a lubricated contact patch by relying upon shear forces at the fluid film between the rolling elements in the contact patch. Such toroidal traction drives comprise a pair of discs that form a toroidal cavity and two or more rollers that transmit torque between the discs. An example of a toroidal traction drive of known design may be seen by referring to U.S. Pat. No. 5,052,236, which discloses a vehicle powertrain with a conventional torque converter and a forward/reverse gear mechanism at the torque input side of a traction drive variator. The variator contains two toroidal cavities that are arranged in parallel. Each cavity has an input disc, two roller assemblies and an output disc. A helical gearset transfers output power to an offset torque output shaft.

A ratio change in a traction drive such as that shown in the '236 patent includes a valve system for controlling the position of roller elements at the torque input disc and the torque output disc. The valve system has two separate ratio valves and a switching valve for forward and reverse, the operation of the latter being triggered by a shaft rotation direction detector. A stepper motor is included for establishing a target ratio by axially moving a valve sleeve, which surrounds a multiple land valve spool. The relative axial displacement between the valve and the sleeve produces a pressure differential across pressure actuators for changing the ratio of the variator.

When the roller position relative to the axes of the discs of the design of the '236 patent is changed, the rollers will tilt. The direction of the tilt depends on the direction of the roller offset created by the pressure actuators and the direction of the input disc rotation.

A ratio change using a roller offset approach is very fast. A ratio feedback feature, therefore, should be used to control the position of the ratio control valve to prevent target overshoot and ratio instability.

A stepper motor typically is used in the design of the '236 patent to adjust the position of the valve sleeve. A four-way control valve spool within the sleeve is attached to a movable portion of the transmission, such as the piston shafts of the pressure actuators. A cam and follower is used for this purpose as the stepper motor adjusts the hydraulic pistons of the pressure actuators. A trunnion and yoke assembly, which supports the rollers, is tilted as the cam and follower move the four-way valve spool to reduce the relative displacement between the sleeve and the valve spool. This adjusts the pressures across the pressure actuators to a new null state. The transmission ratio will remain fixed at the adjusted value until the force balance on the actuators changes.

The valve system disclosed in the '236 patent includes a movable valve in a valve bore formed in a valve sleeve. Precision machining is required to make the valve and the sleeve register, one with respect to the other, with minimal dimensional tolerance. Further, the stepper motor is required to have a small step size as it controls the pressure differential across the pressure actuators and the flow to and from the pressure cavities of the actuators. A duplicate valve system must be used to achieve both forward drive and reverse drive.

Each valve requires separate stepper motor sleeves, feedback cams and feedback levers.

### SUMMARY OF THE INVENTION

The valve system of the invention uses only two valves to control ratio in both the forward drive mode and the reverse drive mode. A single ratio valve and a single ratio range control valve achieve the same function as the more complex multiple valve assembly of prior art systems, such as the system of the '236 patent.

The ratio valve of the invention includes a four-way valve spool that is attached to an intermediate portion of a valve actuating lever assembly. One end of the lever assembly is attached to a stepper motor, and the other end has a roller-type cam follower that engages a cam. The cam is located on any one of the actuator piston assemblies for the traction rollers. The stepper motor sets a target ratio by axially moving the ratio valve from a so-called “null” state. This changes the pressure differential across the pressure actuators for the rollers and the trunnions that support the rollers. As the actuators move the rollers, side slip occurs at the contact patch for the rollers and discs. The amount of the side slip depends on the displacement and the direction of the roller offset relative to the disc centerline.

This side slip causes the rollers and the trunnion assemblies to tilt to a new ratio position. As the trunnion assembly tilts, the cam and lever move back to a null position. The actuators return to a balanced position as the pressure differential across the actuators achieve the new null state.

The ratio valve of the valve system of the invention does not require a valve sleeve. The four-way flow valve is a simple machined part that does not require cross-drilling. The lever assembly itself consists of simple elements that can easily be assembled with a stepper motor. The step sizes of the stepper motor can be twice as great as the corresponding step sizes of the stepper motor of prior art designs because the lever geometry causes the valve to move only half the stepper motor travel.

In practicing the invention, the torque input discs and the torque output discs have a common rotary axis. First rollers are disposed in the first of the toroidal cavities, and second rollers are disposed in the second of the toroidal cavities.

First and second trunnion and yoke assemblies rotatably support the first and second rollers for rotation about roller axes whereby the rollers transmit torque between the discs due to contact from components in a direction transverse to the common axis of the discs. Separate pressure actuators adjust the trunnion and yoke assemblies in a direction transverse to the axis of the discs whereby the roller axes are adjusted to effect an infinitely variable ratio change.

A pressure distributor circuit between a pressure source and the actuators includes a ratio valve with a movable valve element to effect a pressure differential across the actuators as the valve element is adjusted. A valve motion feedback, closed loop control maintains a null position for the valve element when a target ratio is achieved.

### BRIEF DESCRIPTION OF THE DRAWINGS

FIG. 1 is a schematic representation of a traction drive in an automotive vehicle powertrain;

FIG. 2 is a cross-sectional view of the transmission of FIG. 1 as seen from a plane perpendicular to the axis of the traction drive of FIG. 1, looking forward;

FIG. 3 is a schematic representation of the reaction force diagram on the front right trunnion assembly for the traction roller seen in FIG. 1, the reaction forces being established at the contact patch between the toroidal surfaces of the discs and the periphery of the rollers;

FIG. 3a is a schematic representation of the direction of the input torque on the torque input disc as viewed from the plane of section line 3a-3a of FIG. 3;

FIG. 3b is a schematic representation of the friction torque on the torque output disc as viewed from the plane of section line 3b-3b of FIG. 3;

FIG. 3c is a top view of a roller and disc assembly of FIG. 3;

FIGS. 4, 4a, 4b and 4c are schematic representations of the traction drive elements corresponding to FIGS. 3, 3a, 3b and 3c, respectively, which illustrate the ratio change velocity diagrams corresponding to the torque diagrams of FIGS. 3, 3a, 3b and 3c (FIG. 4a is viewed from the plane of section line 4a-4a of FIG. 4 and FIG. 4b is viewed from the plane of section line 4b-4b of FIG. 4);

FIG. 5 is a cross-sectional view of a ratio control valve of the kind used in a conventional traction drive arrangement, such as that of the '236 patent;

FIG. 6 is a schematic representation of the ratio control system of the invention;

FIG. 7 is a subassembly view of the control system of the invention showing the improved ratio control valve;

FIG. 8 is a detailed subassembly view of the control valve system of the invention including the ratio range control valve;

FIG. 9 is a plot of the axial clamping load on the toroidal discs versus the variator input torque;

FIG. 10 is a plot showing the relationship between input torque and pressure at the pressure actuators; and

FIG. 11 is a schematic system diagram showing the signal flow paths for the variables for a feedback, closed-loop arrangement of the controller, the electro-hydraulic controls and the traction drive of the invention.

### DETAILED DESCRIPTION OF THE PREFERRED EMBODIMENT(S)

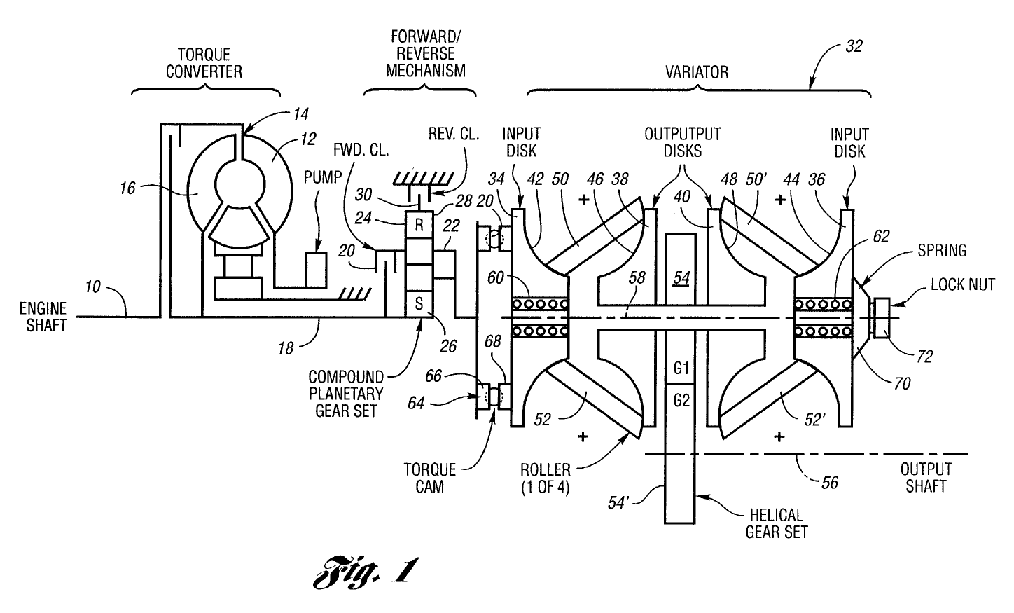

FIG. 1 shows in schematic form a traction drive for an automotive vehicle. The vehicle engine crankshaft 10 drives impeller 12 of a hydrokinetic torque converter 14. Turbine 16 of the torque converter 14 delivers driving torque to turbine shaft 18, which is connected through a forward drive clutch 20 to a compound planetary carrier 22 for a compound planetary gearset 24. Turbine shaft 18 delivers torque to sun gear 26 when the clutch 20 is disengaged. Ring gear 28 is anchored to the housing through reverse brake 30.

The gearset functions in a conventional manner as a forward and reverse gear mechanism. When brake 30 is applied, carrier 22 is driven in a reverse direction relative to the turbine shaft 18. When clutch 20 is applied and the brake 30 is released, the carrier 22 is driven in unison with turbine shaft 18.

An infinitely variable ratio variator, shown generally at 32, comprises tandem torque transmitting input and output disc assemblies. It includes two torque input discs 34 and 36 and two torque output discs 38 and 40. Each disc has a toroidal traction drive surface, the toroidal surfaces for the input discs 34 and 36 being shown at 42 and 44, respectively. The toroidal surfaces for the torque output discs 38 and 40 are shown at 46 and 48, respectively. The toroidal surfaces are juxtaposed, one with respect to the other, to define a toroidal cavity. Traction drive rollers situated in the toroidal cavities are capable of transferring torque between the input discs and the output discs. The traction drive rollers for discs 34 and 38 are shown at 50 and 52. This torque transfer results from tangential lubrication oil shear forces at a contact patch between each roller and the toroidal discs. The corresponding rollers for the discs 36 and 40 are shown at 50′ and 52′.

The torque output discs 38 and 40 are drivably connected to a final drive gear 54, which meshes with gear 54′ to form a final drive helical gear reduction, gear 54′ being connected to torque output shaft 56.

The torque input discs 34 and 36 are connected together for rotation in unison by an intermediate shaft 58. The discs are adapted for limited axial movement relative to the shaft 58 by reason of the ball spline connections shown at 60 and 62, respectively.

A torque cam 64 comprises a first cam element 66, which is connected to the compound carrier 22 and a cam element 68 connected to the intermediate shaft 58. The torque cam elements receive torque transfer balls 20 located in cam pockets formed in the cam elements 66 and 68.

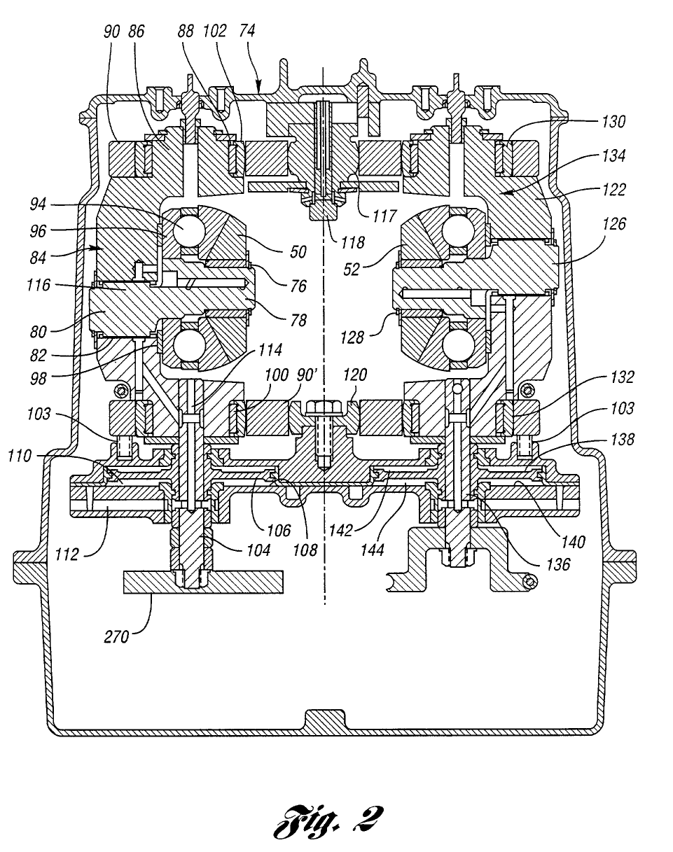

When torque is delivered through the forward and reverse mechanism to the torque input discs, the torque cam will develop an axial thrust on the torque input discs. This creates a force load on the rollers as they engage the toroidal surfaces 42, 44, 46 and 48. The rollers are independently journalled on the trunnion assembly, which will be described with reference to FIG. 2, so that each roller rotates about its geometric axis as torque is applied to the torque input discs.

In the embodiment shown in FIG. 1, a Belleville spring 70 exerts an axial pre-load force on the torque output disc 38, which is transmitted through the rollers and through discs 40, 38 and 34 as an axial thrust force is delivered to torque input disc 34 by the torque cam 64. The spring 70 is held axially fast on the shaft by a lock nut 72.

FIG. 2 is a cross-sectional view of the transmission taken on a plane oriented 90° from the plane of FIG. 1.

A transmission housing 74 encloses the rollers 50 and 52. The rollers 50 are journalled by bearings 76 on mounting shaft 78. Shaft 78 includes an offset portion 80, which is journalled by bearings 82 in trunnion 84. The mounting axis of the offset portion 80 is displaced from the axis of rollers 50.

One end 86 of the trunnion 84 is journalled by bearing 88 in a bearing opening formed in trunnion yoke plate 90. The outer surface of bearing 88 is crowned, as shown at 92, to permit limited articulation of the trunnion relative to the trunnion yoke plate 90.

Thrust forces on the rollers 50 are distributed through thrust ball bearings 94 to the thrust plate 96 and through thrust washer 98 to the trunnion 84.

The opposite end of the trunnion 86 is journalled by bearing 100 in a bearing opening formed in a support plate 90′ of the trunnion yoke. As in the case of the bearing 88, the bearing 100 has a crowned outer surface 102, which registers with the opening in the trunnion yoke support plate 90′ with a limited degree of articulation.

Springs 103 may be located between the housing 74 and the yoke plates 90 and 90′ to provide a compliant support for the yoke plates within the housing.

The trunnion 84 is connected to a piston shaft 104. A pressure actuator piston 106 is secured to the shaft 104.

Although yoke plates 90 and 90′, are part of a unitary yoke structure, they are capable of limited adjustment relative to housing 74 in the direction of the axis of the trunnions as the piston 106 is adjusted.

The housing defines a cylinder 108 that receives the piston 106. First and second pressure cavities 110 and 112 are defined by the cylinder 108 and the piston 106. Pressure can be distributed to the chambers 110 and 112 through internal passage structure not shown in FIG. 2. Lubrication oil passages 114 are formed in the trunnion assembly 84 and the shaft 104.

The trunnion and yoke assembly comprises a trunnion portion 116 that is end supported by the bearings 88 and 100 in the trunnion assembly yoke support plates 90 and 90′. The yoke support plate 90 has a central opening that receives spherical bearing member 117 secured to the transmission housing 74 by a clamping bolt 118. Similarly, trunnion assembly yoke support plate 90′ has a central opening that receives a spherical bearing 120, which also is secured to the transmission housing.

Roller 52 is mounted on trunnion portion 122, which forms a part of a trunnion assembly 124. Offset shaft 126 is received in a bearing opening formed in the trunnion portion 122. The offset shaft 126 rotatably supports rollers 52 by bearings 128. The end supports for the trunnion assembly are provided by crowned bearings 130 and 132 received, respectively, in yoke support plates 90 and 90′. The construction of the rollers 52 is similar to the construction of the rollers 50.

The trunnion assembly is connected to a piston shaft 136, which is connected to piston 138 located in cylinder 140 formed in the transmission housing 74. Piston 138 and cylinder 140 define opposed pressure chambers 142 and 144. Like piston 106, displacement of piston 138 will cause compliant articulation of the yoke plates.

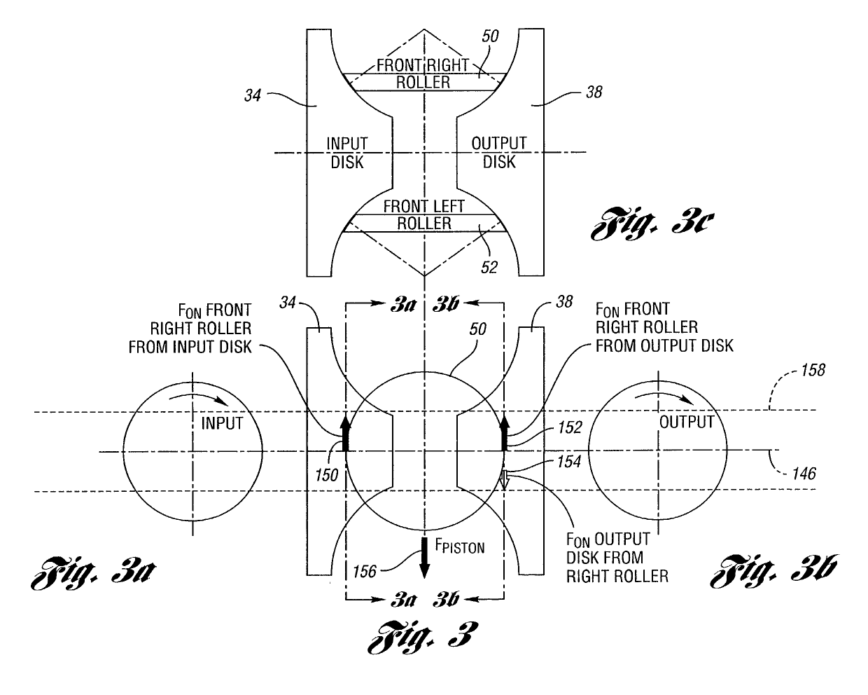

In FIG. 3c, the rollers 50 are shown in the position relative to the input and output discs that would establish a one-to-one driving ratio between the discs. FIG. 3c is a top view of the roller and disc assembly as seen in FIG. 3b, which is a side view of the assembly. When the pressure in chambers 110 and 144 is increased relative to the pressure in chambers 112 and 142, rollers 52 will move vertically upward and rollers 50 will move downward when viewed from the perspective of FIG. 3.

FIG. 3 is a schematic diagram that shows the forces on the front right roller, the piston, and the trunnion assembly when the roller's rotational axis is at the same elevation as that of the input and output discs.

It should be noted that the roller and trunnion assembly can move up or down from this null position by the hydraulic piston actuator. FIG. 3a shows the direction of rotation of the input disc. FIG. 3b shows the direction of rotation of the output disc. FIG. 3c shows a top view of the front cavity with the left and right rollers in approximately the one-to-one ratio position.

When the input disc is turning in the forward or clockwise direction, it exerts a force 150 on the front right roller. The front right roller, in turn, exerts a force 154 on the output disc. The reaction force on the front right roller due to applying force 154 is force 152. For the roller, piston and trunnion assembly to be in balance, the hydraulic piston 106 must exert a force 156 equal in magnitude and opposite in direction to the sum forces 150 and 152.

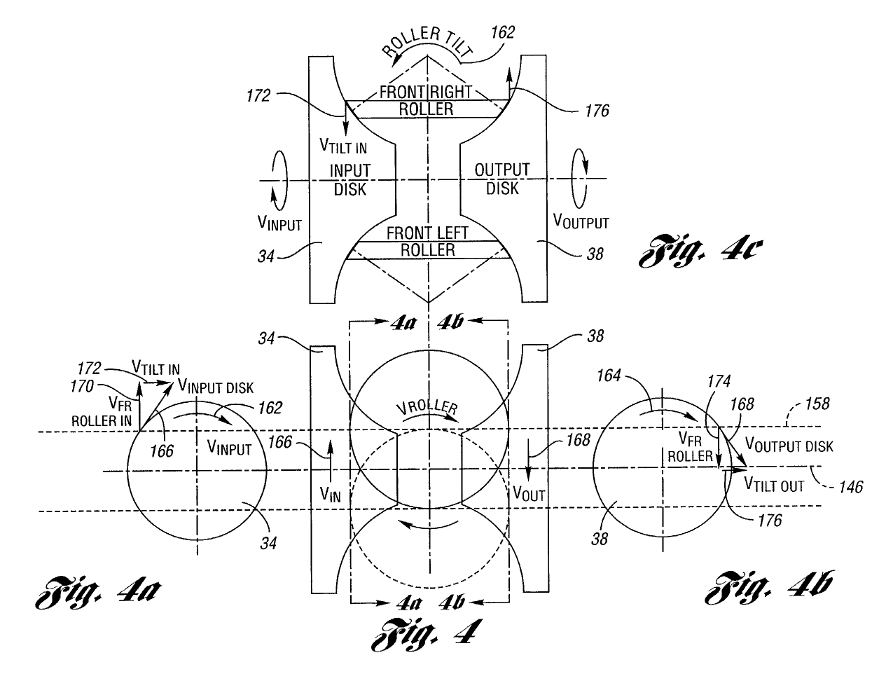

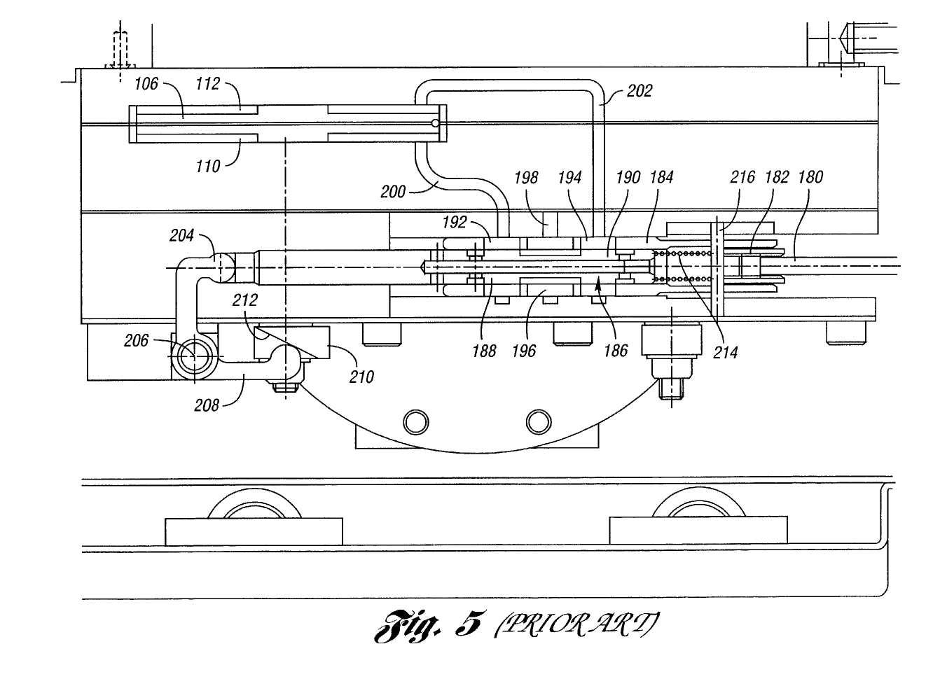

As the roller 50 moves vertically, the axis of the roller, seen at 158, will be offset from the input and output disc axis 146 and the rollers will tilt, as shown in FIG. 1. This will be explained with reference to FIGS. 4, 4a, 4b and 4c.

When the rollers are displaced from the axis of the discs, the velocity component at the contact patch between the roller 50 and the output disc is represented by vector 158. The corresponding vector at the contact patch between the roller 50 and the input disc 34 is shown at 160. This velocity vector component induces a tilting force on the roller 50, as indicated by the torque vector 162.

If it is assumed that the roller 34 is rotating in the direction of the velocity vector 162 in FIG. 4a, the disc 38 will rotate in the direction of the velocity vector 164 in FIG. 4b. The corresponding velocity vector for the input disc at the contact patch for the front right roller 50 is shown at 166. The velocity vector 168 is the velocity at the contact patch between the front right roller and the output disc 38. When the rollers are moved so that their centerline is at 158, the front right roller velocity vector would be represented as shown at 170 in FIG. 4a. The vectorial sum of the vectors 166 and 170 is shown at 172. This represents the velocity vector for roller tilt.

The corresponding velocity vector diagram for the output disc is shown in FIG. 4b. When the front right roller 50 is shifted to axis 158, the velocity vector at the contact patch between the rollers 50 and the output disc 38 can be represented as shown at 174.

The vectorial sum of the vectors 168 and 174 is seen at 176. This is the velocity vector representing the tilting motion of the rollers 50. When the roller position is moved as shown in FIGS. 3b and 4b from the null position corresponding to axis 146, velocity induced tilting forces are created on the roller 50. These cause the rollers to tilt about their vertical axes. The direction of the tilt depends on the direction of roller offset from the axis of the input and output discs and on the direction of input disc rotation. The front right roller 50 tilts toward the underdrive position when the roller is above the disc centerline for forward rotation. The resulting ratio change direction for both cylinders is summarized as follows:

FORWARD ROTATION

| | ROLLER | ROLLER |
|---|---|---|
| ROLLER LOCATION | ABOVE NULL | BELOW NULL |
| Front Left (FL) | OD | UD |
| Front Right (FR) | UD | OD |
| Rear Left (RL) | OD | UD |
| Rear Right (RR) | UD | OD |

REVERSE ROTATION

| | ROLLER | ROLLER |
|---|---|---|
| ROLLER LOCATION | ABOVE NULL | BELOW NULL |
| Front Left (FL) | UD | OD |
| Front Right (FR) | OD | UD |
| Rear Left (RL) | UD | OD |
| Rear Right (RR) | OD | UD |

Implementing a ratio change using the roller offset approach results in a very fast ratio change. The complete ratio change can be accomplished, for example, with only six revolutions of the input discs with a minimum offset of about 2 mm. In one embodiment of the invention, a complete ratio change may occur in 0.072 seconds at an input speed of 5000 rpm. This rate of change of ratio makes it very desirable to use ratio feedback on the valve control system, which will be described subsequently. This will prevent a target ratio overshoot with a resulting ratio instability.

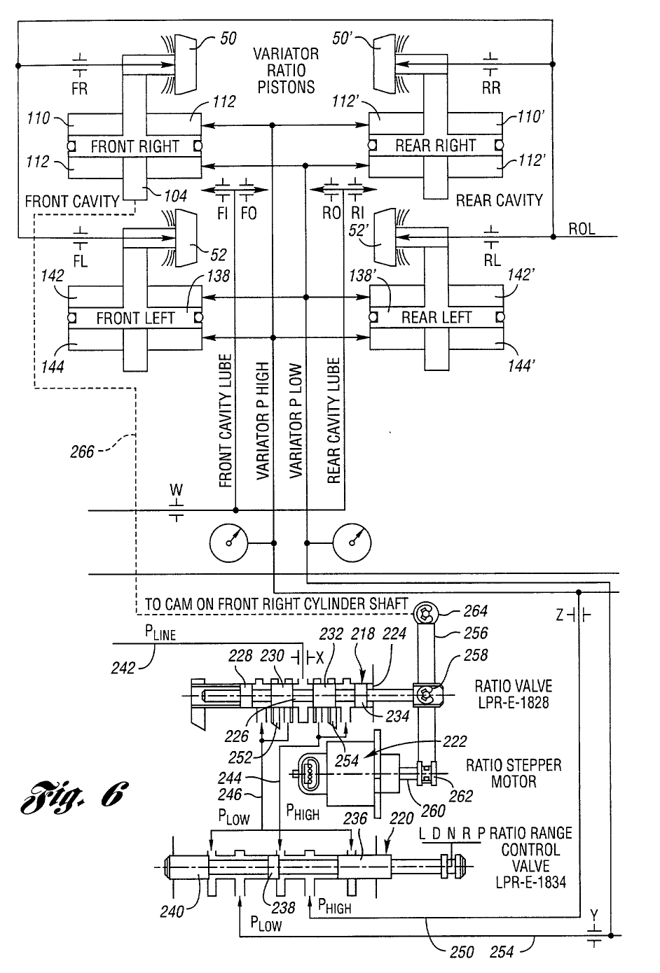

In order to compare the control valve system of the present invention with known valve systems in a traction drive of this type, reference will be made to FIG. 5, which illustrates a ratio control valve of the kind disclosed in the '236 patent. A stepper motor shaft 180, seen in FIG. 5, has a threaded connection at 182 with a valve sleeve 184. A four-way valve spool 186 has axially spaced valve lands 188 and 190, which register with valve ports 192 and 194, respectively, in the sleeve. A line pressure supply port 196 in the sleeve 184 communicates with line pressure passage 198 in the valve body.

Pressure passage 200 distributes pressure from port 192 to pressure chamber 110 on one side of piston 106. Pressure passage 202 distributes pressure from port 194 to pressure chamber 112 on the other side of the piston 106. When the valve sleeve and the valve spool are in the position shown in FIG. 5, the pressure forces on opposite sides of the of the piston 106 are balanced with respect to the torque-induced roller forces. This corresponds to the null position for the torque transmitting rollers.

The left end of the spool valve 188 engages a valve link 204, which is pivoted at 206 on the valve housing. An arm 208 of the valve link extends to a cam 210 connected to and movable with one of the control piston shafts. The end of the link 208 engages a cam surface 212 on the cam 210. The cam link is held in sliding engagement with the cam surface 212 by valve spring 214 situated between spring anchor pin 216 and the right-hand end of the valve spool 186.

The stepper motor seeks a target ratio by axially moving the sleeve 184. The pressures in the chambers 110 and 112 are changed as a result of the new relative position of the valve and the sleeve. The hydraulic pistons, one of which is shown at 106, move up or down depending on the pressure differential. Side slip occurs on the rollers as the rollers are adjusted upward or downward depending on the amount and the direction of the offset from the disc centerline. The side slip causes the rollers to tilt, thereby establishing a new transmission ratio. As the trunnions move, the cam link moves the valve to reduce the displacement of the sleeve relative to the valve. Once the rollers reach the desired ratio position, the valve overshoots, reversing the piston pressures. The piston returns to the disc centerline, and the ratio change is complete. The ratio will remain at that new value until the sleeve is moved, causing the force balance on the pistons again to change.

The valve and sleeve of the valve system of FIG. 5 must be assembled in a bore as part of a relatively complex assembly procedure. The valve and sleeve, furthermore, require precision machining. The stepper motor for the design illustrated in FIG. 5 must have a very small step size to control precisely the pressure differential across the pistons. The follower moves up and down along the cam surface 212, thereby changing the valve position when the hydraulic piston moves off the null point, even before any ratio change has occurred. Similarly, there is movement of the valve when the hydraulic piston returns to its null state.

The valve arrangement shown in FIG. 5 functions only during forward rotation. A separate ratio valve and duplicate stepper motor sleeves, cam and feedback levers are required to effect reverse drive. Further, a switching valve is needed to select the appropriate ratio valve for reverse drive mode or forward drive mode.

In contrast to the valve arrangement of FIG. 5, the improved valve arrangement of the present invention, which is shown in FIGS. 6, 7, 7a and 8, comprises a ratio valve 218 and a ratio range control valve 220, which replace the multiple valves of the FIG. 5 design. The design of the present invention includes a single stepper motor 222.

The ratio control valve of the invention has a valve body 223 with a valve chamber 224, which receives valve spool 226 with four axially spaced valve lands 228, 230, 232 and 234.

The ratio range control valve 220 has a valve spool with multiple lands, as shown at 236, 238 and 240, which are slidably positioned in a valve bore formed in the valve body.

The ratio valve 218 receives line pressure from a positive displacement transmission pump through line pressure passage 242. Pressure is distributed to high pressure passage 244 and low pressure line 246 as the position of the valve spool 226 is adjusted to the right or to the left. When it is adjusted to the right, communication between passage 244 and an exhaust port 248 is decreased, and communication between passage 242 and passage 244 is increased. The ratio range control valve distributes the high pressure to the high pressure chambers 140, 112, 112′ and 140′ through high pressure passage 250. Simultaneously, valve land 230 increases communication between exhaust port 252 and passage 246 while decreasing communication between passage 242 and passage 246. This creates a relatively low pressure in passage 254, which communicates with pressure chambers 110, 142, 110′ and 142′.

The relative pressures in passages 250 and 254 can be reversed by shifting the valve 220 to reverse position R from the drive range position D. The valve 220 is shown in the neutral position N in FIG. 6 so that high pressure is distributed to passage 250 and low pressure is distributed to passage 254.

Movement of the ratio valve spool 226 is achieved by ratio valve lever 256, which is pivotally connected at 258 to the right end of the valve spool 226. The lower end of the lever 256 is connected to the torque output shaft 260 of stepper motor 222, as shown at 262. The shaft moves in and out of the stepper motor through a threaded connection of the kind previously described with reference to FIG. 5. The connection at 262 may be a pin extending from the lever between two lands on the output shaft.

The lever 256 engages a cam link schematically shown at 264. The cam link 264 is connected mechanically to a cam follower on the front right piston shaft 104 as represented by the dotted line 266. The cam on the front right piston shaft 104 may be similar to the cam 210, shown in FIG. 5.

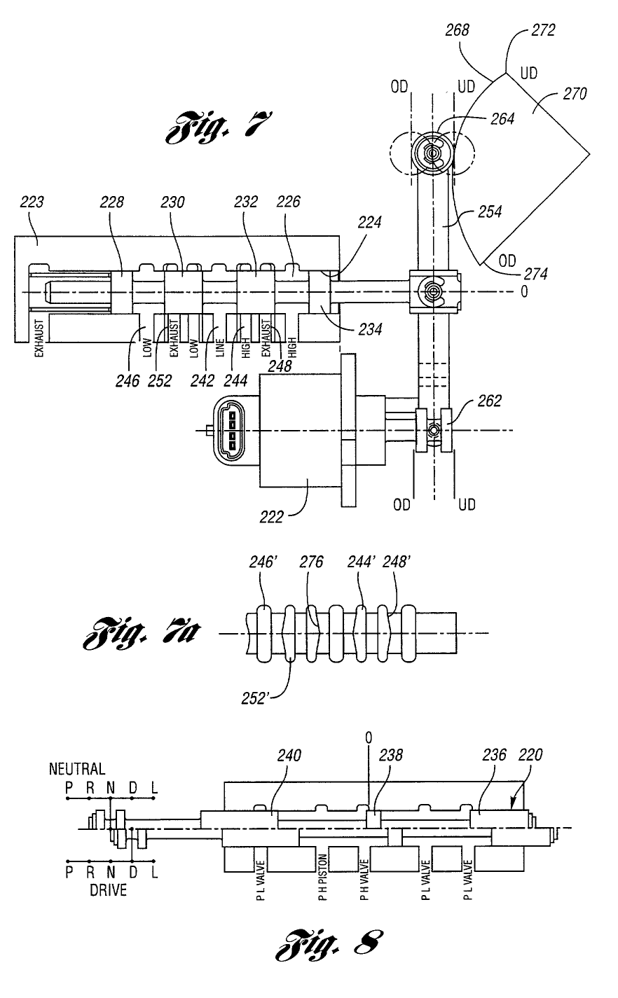

FIG. 7 shows schematically an alternate cam arrangement with an arcuate cam surface 268 on a cam element 270 connected to the front right piston shaft 104. The underdrive position of the cam element is shown at 272, and the overdrive position is shown at 274.

FIG. 7a shows schematically an alternate valve port arrangement for the valve 226. It includes tapered valve port edges 276 in the valve housing. The valve ports in the embodiment of FIG. 7a are designated by numerals with prime notations. These ports correspond to the ports illustrated in FIG. 7 where corresponding reference numerals are used. The tapered ports permit finer pressure control by the stepper motor if additional fine-tuning is needed.

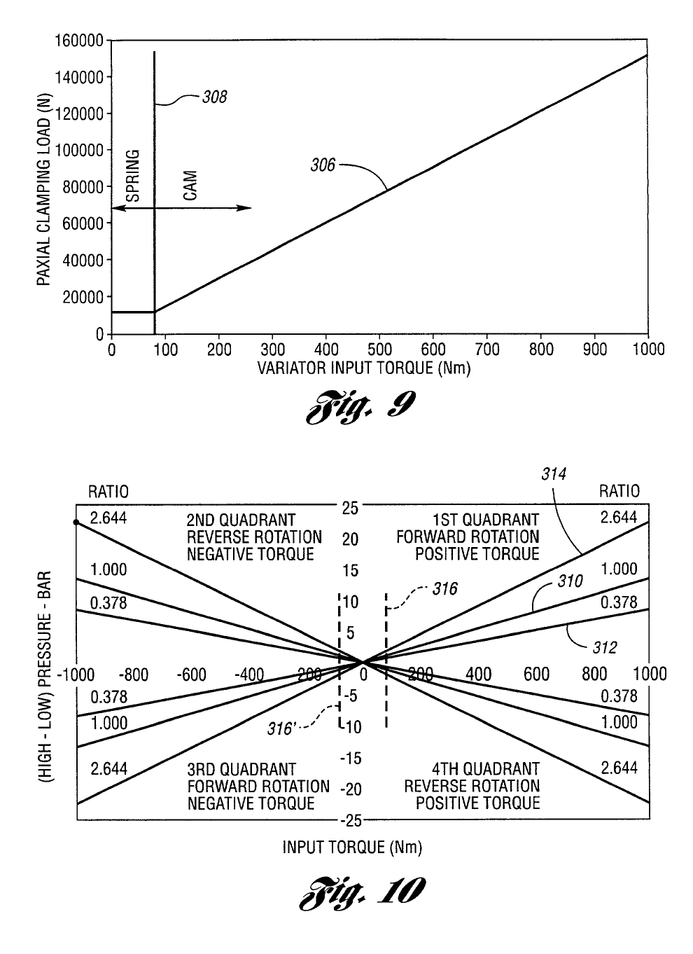

FIGS. 7 and 8 show enlargements of the ratio valve and the ratio range control valve described with reference to FIG. 6.

There is no necessity for a valve sleeve in the valve arrangement of FIG. 6. The valve spool is a simple valve element that can be manufactured, for example, on a metal cutting lathe. Further, no cross-drilling is needed.

The lever assembly of the valve arrangement of FIG. 6 has simple components that are easily assembled. The stepper motor step sizes can be twice that of known valve systems in traction drives of this kind because the lever geometry permits the valve to move only one-half of the stepper motor travel when the valve is connected to the center of the lever 256.

There is no control input to the valve when the hydraulic piston moves up or down. Ratio feedback is the only input. A roller on the lever assembly eliminates any sliding action on the cam during a ratio change.

The ratio range control valve is used merely to switch the hydraulic circuits that feed the pistons. It is attached to the same mechanism that actuates the transmission manual valve for forward and reverse clutch operation. A rotation direction sensing actuator, such as that shown in the '236 patent, is not required.

FIG. 11 shows a schematic representation of the overall transmission system. It includes an electronic powertrain digital controller 280, which receives driver-selected input signals from drive range selector sensor 282, throttle position sensor signal 284 and brake on/off sensor 286.

The controller 280 processes input information and develops a stepper motor ratio control signal 288 and a line pressure signal 290 for a variable force solenoid. The signals from the controller are received by the electrohydraulic controls and pump circuit 292. As previously described, a variator high pressure and a variator low pressure for the trunnion actuating pistons is developed, as shown at 294 and 296. The traction drive itself is shown at 298. The front right roller piston actuates cam element 270 and provides mechanical tilt feedback as shown at 306. Also the front right piston position actuates a position sensor, as previously described, to produce an electrical feedback signal at 300, which is received by the powertrain controller.

The position sensor feedback signal can be used to prevent “overshoot” of the valve spool as the piston is moved axially. At the outset of a ratio adjustment, movement of the piston occurs before a response by the valve spool. Overshoot of the valve is prevented as the stepper motor is deactivated slightly before the target ratio position for the actuator motor armature is reached. Movement of the valve then will terminate at the target ratio position. The position sensor signal feedback at 300 and 306 to the control module 280 makes this possible.

Other feedback signals are the variator input speed signal in signal flow path 302 and variator output speed signal in the signal flow path 304. These correspond, respectively, to turbine speed and the output shaft speed. These variables, together with the driver selected input variables, are processed by the controller 280 to develop the processor driver signals shown at 288 and 290.

FIG. 9 shows the axial clamping force that is required for a given variator input torque. The clamping force, as previously explained, is developed by the torque cam 64. In the example shown in FIG. 9, the relationship between axial clamping load and variator input torque is a linear, straight-line relationship, as shown at 306. The input torque capacity developed by Belleville spring 70, shown in FIG. 1, in the example shown in FIG. 9 is about 80 Newton meters (Nm), as indicated at 308. Variator input torque in excess of about 80 Nm is due to the cam torque clamping force.

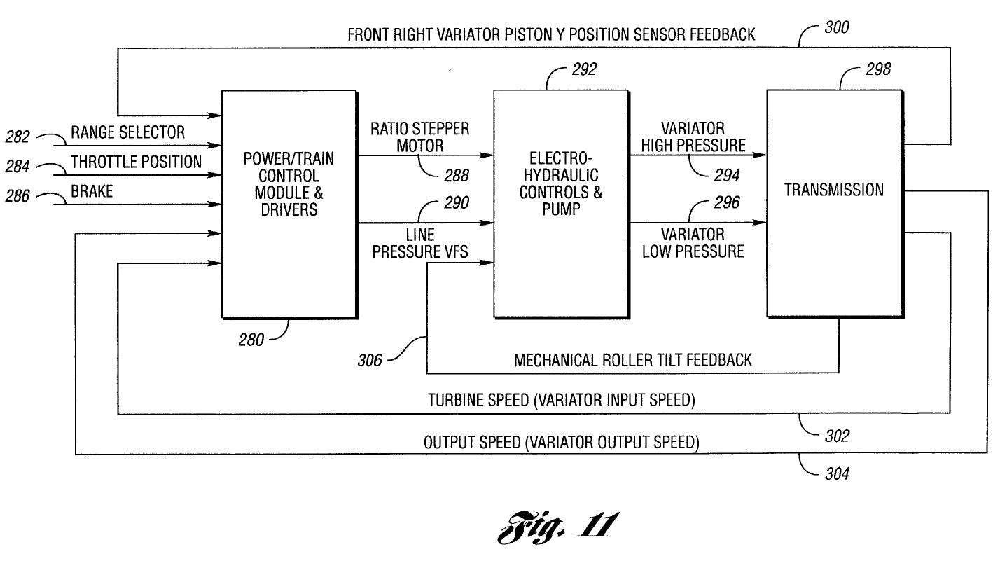

FIG. 10 shows the relationship between the required null differential pressure acting on the trunnion pistons for input torque in both forward rotation and reverse rotation. A one-to-one driving ratio for the transmission in forward, which is represented by FIG. 4c, is shown in FIG. 10 at 310. The overdrive state, which is schematically illustrated in FIG. 1, is shown in FIG. 10 at 312. The underdrive state is shown at 314. These ratio changes occur as the rollers shift from the positions shown in FIG. 1 to an angular position beyond the position shown in FIG. 4c in an underdrive direction or in an overdrive direction. The minimum pressure that is needed for the Belleville spring is indicated by the dotted lines 316 and 316′ in FIG. 10.

When the variator is in the direct-drive position indicated at 310 in FIG. 10, the rollers will assume the position shown in FIGS. 3c and 4c. The first equation for the static condition indicated in FIGS. 3c and 4c is expressed as follows:

F_{P}=2*F_{T}

Where:

Fₚ (force of the piston)=(P_{H}−P_{L})*A and F_{T}=T_{IN}/ (4*R_{IN})

The piston pressure schedule, using the foregoing information, is expressed for one embodiment of the invention as follows:

(P_{H}−P_{L})=T_{IN}/(2*R_{IN}*A)

Where:

| | |
|---|---|
| A | = Piston net pressurized area = 10.60 in² |
| R_{IN} | = Radius on input disc of roller contact |
| T_{IN} | = Variator input torque |
| F_{P} | = Piston net force |
| F_{T} | = Contact path tractive force |
| P_{H} | = Piston high circuit pressure |
| P_{L} | = Piston low circuit pressure |

It is seen from the foregoing that the piston differential pressure schedule is a function of the variator input torque, the input disc contact radius for a given ratio and the piston apply area. FIG. 10, as previously explained, shows the required variator piston pressure schedule for equilibrium for each of a variety of ratios including maximum underdrive ratio and maximum overdrive ratio.

To effect a constant ratio, roller centers are at the centerline of the input disc and the output disc, i.e., axis 146 in FIGS. 3 and 4. Ratio change is accomplished by raising or lowering the roller assemblies relative to the centerline of the input and output discs. When the roller is moved vertically from the null position, the velocity-induced tilting forces cause the power roller to swing about the vertical axis, as explained previously. The front right roller will swing toward underdrive when the roller is above the disc centerline in forward rotation.

Although one embodiment of the invention has been disclosed, it will be apparent to persons skilled in the art that modifications may be made without departing from the scope of the invention. All such modifications and equivalents thereof are intended to be covered by the following claims.

What is claimed:

1. A control valve system for an infinitely variable traction drive comprising a pair of torque input toroidal traction discs connected to a torque input shaft, a pair of torque output discs drivably connected to a torque output shaft;
a first torque input disc and a first torque output disc defining a first toroidal cavity;
a second torque input disc and a second torque output disc defining a second toroidal cavity;
the torque input discs and the torque output discs having a common rotary axis;
first rollers disposed in the first toroidal cavity and second rollers disposed in the second toroidal cavity;
first and second trunnion and yoke assemblies for rotatably supporting the first and second rollers, respectively, for rotation about roller axes whereby the rollers engage toroidal surfaces on the first and second torque input discs and the first and second torque output discs and transmit torque between the torque input discs and the torque output discs as the rollers develop contact force components in a direction transverse to the common axis of the torque input and torque output discs;
separate pressure actuators for adjusting the trunnion and yoke assemblies in a direction transverse to the axis of the discs whereby the roller axes are angularly adjusted to effect an infinitely variable ratio change;
a pressure distributor circuit between a pressure source and the pressure actuators including a ratio valve means with a movable valve element for effecting a pressure differential at the pressure actuators when the movable valve element is adjusted in one direction; and
a valve element motion feedback closed loop control means for maintaining a null position for the ratio valve means when a target torque ratio for the traction drive is achieved.

2. The control valve system set forth in claim 1 wherein the feedback closed loop control means comprises an actuator lever connected at an intermediate location to the movable valve element of the ratio valve means, a motion transducer means for translating displacement of the roller axes relative to the common rotary disc axis to one end of the actuator lever and a ratio control motor connected to the other end of the actuator lever whereby the motor adjusts the movable valve element to effect shifting movement of the roller axes from a null position relative to the common rotary disc axis and the feedback closed loop control means returns the valve element to the null position upon completion of a torque ratio change.

3. The control valve system set forth in claim 2 wherein the motor is an electric stepper motor with an output shaft connected to the other end of the actuator lever.

4. The control valve system set forth in claim 3 wherein the motion transducer means comprises a cam connected to a movable element of one of the separate pressure actuators and a cam link between the cam and the one end of the actuator lever.

5. The control valve system set forth in claim 2 wherein each of the pressure actuators for adjusting the trunnion and yoke assemblies comprises a piston and an actuator cylinder defining a pair of pressure chambers on opposed sides of the piston;
the ratio valve means having pressure distribution ports communicating with each pressure chamber and a pressure supply port;
movement of the ratio control motor from a null position in response to a command for a ratio change causing movement of the movable valve element and a pressure differential across the piston;
the valve motion feedback closed loop control means restoring the movable valve element to its null position when ratio change is completed.

6. The control valve system set forth in claim 1 wherein the pressure distributor circuit includes a ratio range control valve between the pressure actuators and the ratio valve means;
the ratio range control valve comprising a movable valve element under the control of an operator to selectively distribute pressure to opposite sides of the pressure actuators to establish ratio changes from a null state toward an overdrive state and to an underdrive state for both forward and reverse operation.

7. The control valve system set forth in claim 5 wherein the pressure distributor circuit includes a ratio change control valve between the pressure actuator pressure chambers on opposed sides of the pistons;
the ratio range control valve comprising a movable valve element under the control of an operator to selectively distribute pressure to opposite sides of the pressure actuators to establish ratio changes from a null state toward an overdrive state and to an underdrive state.
